(19) United States
(12) Patent Application Publication
(10) Pub. No.: US 2015/0206080 A1
(43) Pub. Date: Jul. 23, 2015

(54) SYSTEMS AND METHODS TO CAPTURE PRIORITIZE AND VISUALIZE TACIT AND COLLECTIVE KNOWLEDGE OF BUSINESS STRATEGIES

(71) Applicant: Electronicsonline S.A. de C.V, Tlaquepaque (MX)

(72) Inventor: Francisco Jose Ruiz Izaguirre, Tlaquepaque (MX)

(73) Assignee: Electronicsonline S.A. de C.V., Tlaquepaque (MX)

(21) Appl. No.: 14/395,421

(22) PCT Filed: Apr. 19, 2012
(86) PCT No.: PCT/MX2012/000042

§ 371 Date: Mar. 23, 2015

(51) Int. Cl. G06Q 10/06; G06F 17/30

(52) U.S. Cl. CPC G06Q 10/0637; G06F 17/3053; G06F 17/30867

(57) ABSTRACT

The invention relates to a method and system for including tacit and collective information on the strategic value of new business opportunities and corporate decisions, which can be added to firmware, software or other instructions that can be processed in a computer and/or stored in a computer-readable medium. Said addition can include code which can be executed in a web-based application which, when executed on a business intelligence or customer relationship management system, makes a data-processing device provide a graphical representation of the reported value of new business opportunities and corporate decisions. The graphic representation can include a plurality of fields which are grouped together in a bubble chart with prioritization criteria. The invention provides a method for capturing statistical data regarding tacit knowledge of the business strategy and decisions in an organization by means of a business intelligence (BI) or customer relationship management (CRM) system over the internet.

### BACKGROUND OF THE INVENTION

The spread of a strategy is a complex challenge for the organizations mainly because of the erratic variability of the elements that determine decisions in a particular time. As a result, the companies commonly communicate those elements to the organization mentioning historical commercial transactions that not necessarily reflect elements of the tacit knowledge that are also considered for those particular decisions. This causes the spreading of incomplete information that can cause unwanted results in the evaluations for future decisions.

A known example is when evaluating the resources allocation in order to supply service to the clients, especially when determined by profit per client. The Pareto principle or the “80:20 law” does not apply when measuring profitability per client. Harvard studies demonstrate that instead of the 20% of the clients generating the 80% of the profits, the 20-25% of the clients are in fact non profitable¹. The best sales practices indicate that more time and resources should be invested in profitable clients, and to cut expenses and services to the non-profitable ones. The endemic problem is the lack of visibility of the real profitability per client and per product. As a result, the business transactions that decrease the profit margins are overshadowed by costs averages and are frequently undiscovered. This imposes the sales department to make decisions about specific clients “blindly” and therefore it makes the sales process a bet by intuition². When the sales teams indiscriminately look for new business opportunities, even in the right market segment, they may increase the service costs, ignore the long term growth and reduce earnings on more than 40%¹.

Another factor that provokes the incomplete spread of business information is that various accounting systems are still based on the averaged costing. The installation, logistics and technical support or sales costs are still averaged as a percentage of every unit sold and not in accordance with its real consumption. In order to make a Customer Profitability Analysis, the enterprises usually should hire a high-cost consulting firm in order to analyze the historical purchases or to invest considerable resources inside the company, making impractical the measuring as a steady business process. The CRMs based on the cloud (Cloud computing), capture historical data of the client's activities such as sales, purchases, calls, estimates, support requests, but do not use the tacit organization's knowledge in order to correlate it with the expected success results through algorithms and graphic interfaces that allow evaluations visualizations and collective intelligence about the strategic value of new business opportunities.

Through a system that does not require previous transactions data for business evaluations, the director, managers, vice-presidents and employees responsible for the decisions in a company will use the invention in order to include their strategic decisions, tacit evaluations and to provide basis for other employees and colleagues to be able to evaluate and add their own tacit evaluation in the graphic representation.

Through the graphic representation, the users could visualize the strategic value and the potential risks of the service cost of new business opportunities before the deals are closed, mapping the collective knowledge of the tacit evaluations about the impact on incomes, profitability and long term growth. Additionally, the company could reduce hiring and training costs for the new sales agents. Studies show that when optimizing sales processes, the average sales per salesman could increase until 50% in two or three years¹.

In the same way, the organization may increase the motivation of the sales force through the optimization of the effective communication among the sales agents and their managers³. Finally, the invention also permits an accessible and fast cost alternative to complex studies of high profitability cost.

### BRIEF DESCRIPTION OF THE INVENTION

Due to all of the above mentioned, so far, there are no means to present solutions to problems through subjective data, so groups of people determine to rate or value higher the opinion of each member of the group according to their rank, convincing ability, position, experience or hierarchy. That biases the opinion of the group when the opinion of that person could be less accurate or clever that the one of another member of the group (the phenomenon named “group think” scientifically documented by the Yale researcher Irving Janis).

On the other hand, the group opinion does not become more clever while increasing the amount of people that opine because the method to confront the ideas provoke that they are erratically discarded in accordance with the factors mentioned above and therefore the best ideas for the group solution are not added (phenomenon documented in the book “Wisdom of the crowds” by James Surowiecki).

The invention pretends to provide value to the tacit knowledge and through it, be able to determine a solution to a stated problem.

The present invention consists on transforming the subjective, non-measurable evaluations into numeric evaluations, from 1 to 10 subjective, configurable criteria, graded by the user. For making possible the interpretation, mathematically they were averaged and with an algorithm to transform numeric data and the usage of Euclidian geometry, it creates a visual real-time representation of the group evaluation in a bubble chart, so it allows their visual comparison with others criteria.

### Identification of the Parts/Components of the Invention

### NUMERIC REFERENCE—DESCRIPTIVE NAME OF THE PARTS

10—Visualforcepages Pages
12—Apex Classes
14—Opportunity Personalized fields
16—Flash file Static resource

### BRIEF DESCRIPTION OF THE DRAWINGS

FIG. 1 is a Screen Picture (1) of the incorporation in the application SalesForce.com.

FIG. 2 is a Screen Picture (2) of the incorporation in the application SalesForce.com.

FIG. 3 is a Screen Picture (3) of the incorporation in the application SalesForce.com.

FIG. 4 is a Screen Picture (4) of the incorporation in the application SalesForce.com.

### DETAILED DESCRIPTION OF THE INVENTION

In the convenient incorporation of the illustrated invention, this is an application for CRMs based on the cloud that uses a classifying or ranking algorithm in order to correlate the new business opportunities with the established success criteria. This allows that the sales teams could predict data of the real service costs in specific contracts before they are closed, and visualize strategic profit losses for specific decisions about the clients.

To do that, a process for information classification implemented in a computer allows obtaining real-time data that represents the people's tacit knowledge or subjective evaluations that are not contained in historic files, in a way that, by processing the data, a quantifiable value of each obtained datum could be determined. By calculating and determining the status of the corresponding score for each datum, a group of data with similar scores corresponding to the same object can be generated. By rating each of the inputs scores' criteria, it could plot the obtained values in the appropriate order as a collective opinion indicator.

Technology introduces an affordable solution to capture the intelligence of business in group in real time.

The algorithm of classification or systematization (ranking) can be integrated without complications into other CRM enterprise systems based on the cloud such as Oracle OnDemand, Microsoft Dyanmics CRM, Zoho and SugarCRM eliminating the manual importation of records or high costs of changing from platforms. The application displays classified opportunities (ranked) automatically on a bubble chart allowing the visualization of the sales representative evaluation of the new business opportunities and alignments with the strategic targets of the company. Being this an application which can be attached to an existing CRM system and based on the cloud, the result is an affordable cost structure; payment on a Software as a Service (SaaS) model allows low costs and scalability.

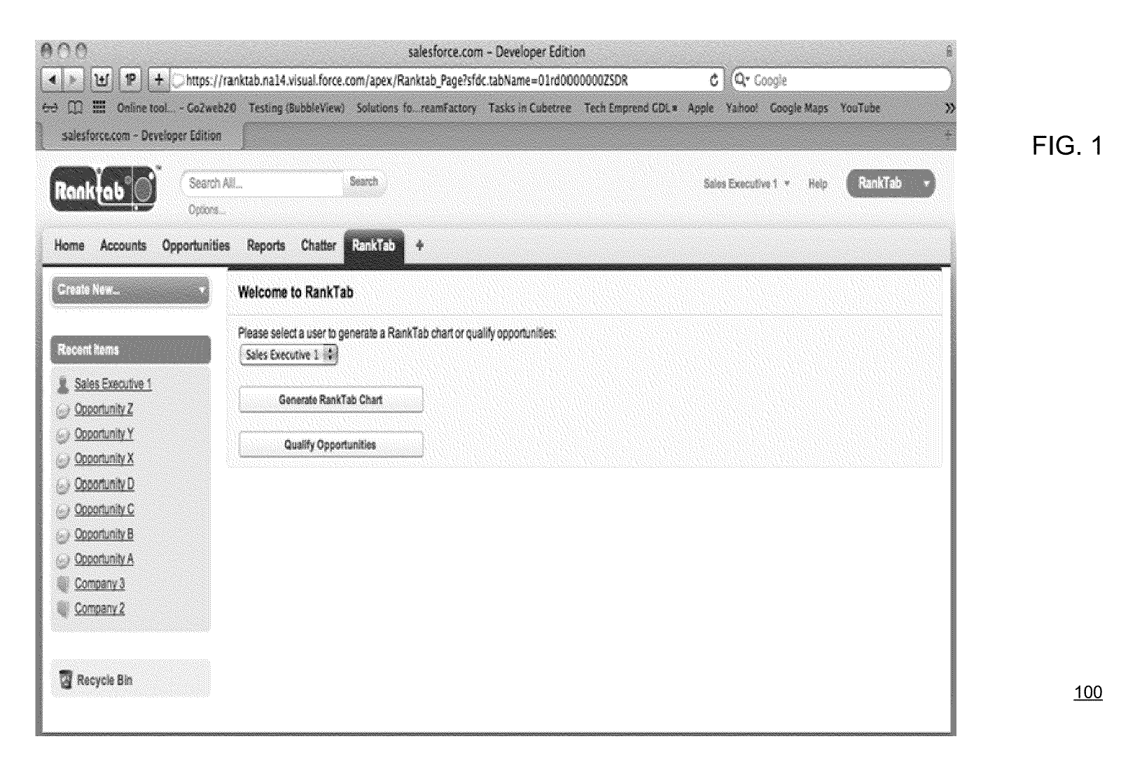

The application is a tab (FIG. 1) with 4 pages Visualforce, 2 classes Apex, 10 personalized fields of Opportunity and a Flash file Static Resource to create opportunities graphics. No trigger Apex is used and the complete application lies in the platform Force.com.

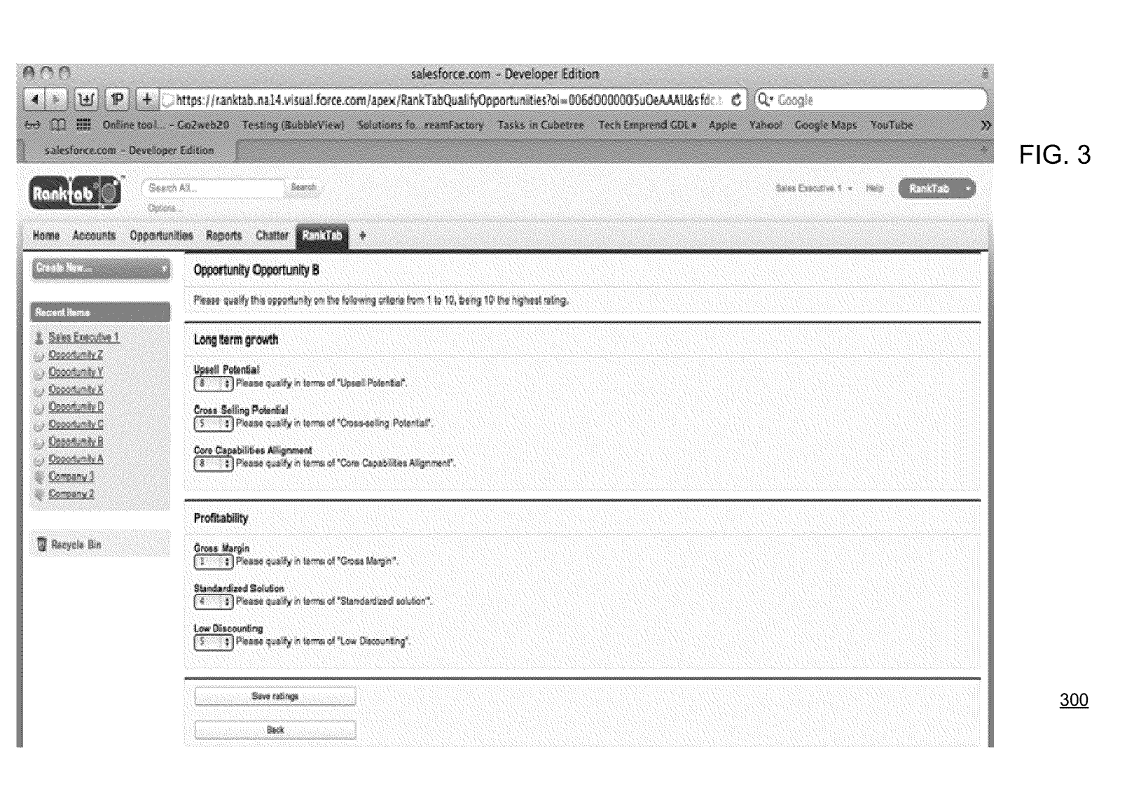

The application uses only one Standard Object, “Opportunity”, to which 10 Personalized Fields were added: Upsell Sales Potential, Cross-selling Sales Potential, and Alignment with Core Capability, Gross Margin, Standardized solution and Low Discounts (FIG. 3).

Through these personalized fields, the users can qualify their opportunities by using Visualforce pages, classes Apex and a Flash file.

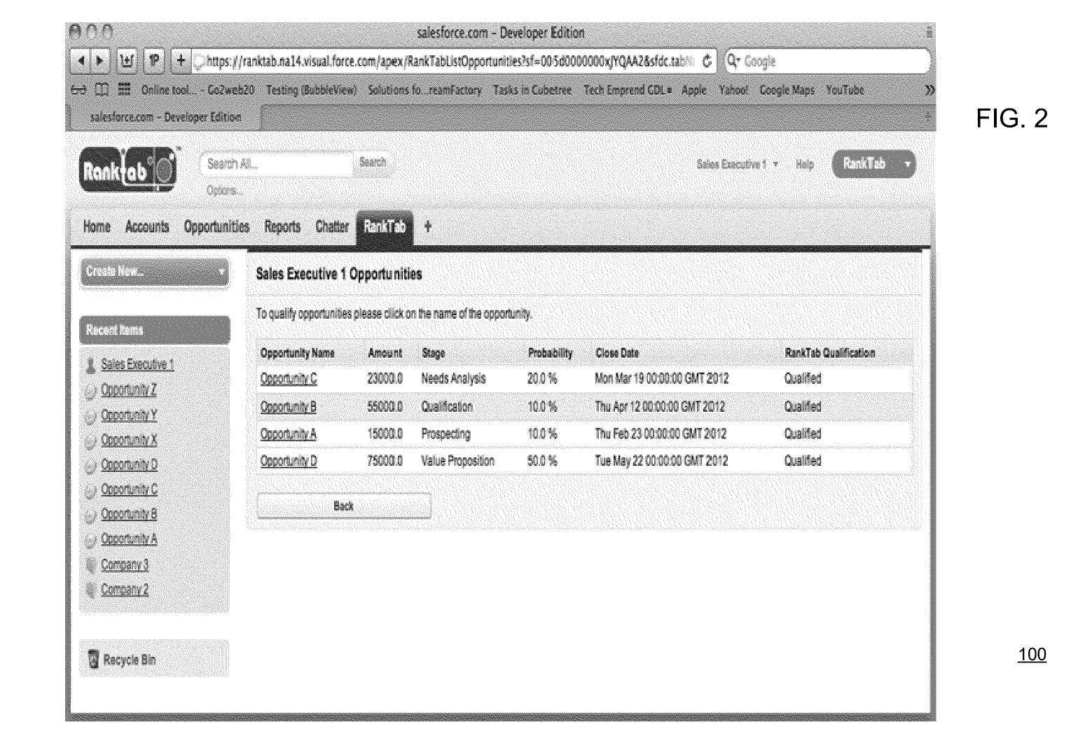

Through three formula fields: Profitability, Long-Term Growth, and Impact on Income are calculated for each opportunity. The field is ranked and indicates the status of each opportunity, with the purpose of informing if it has been rated or not (FIG. 2).

The personalized fields are reported on a Visualforce page named “RankTabQualifyOpportunities” which uses the “ListOpportunities” controller. In this page Visualforce and with a search SQL query, the user can display the opportunities' list in order to rate them; and only the system administrator can access to the opportunities of all the users and rate them too.

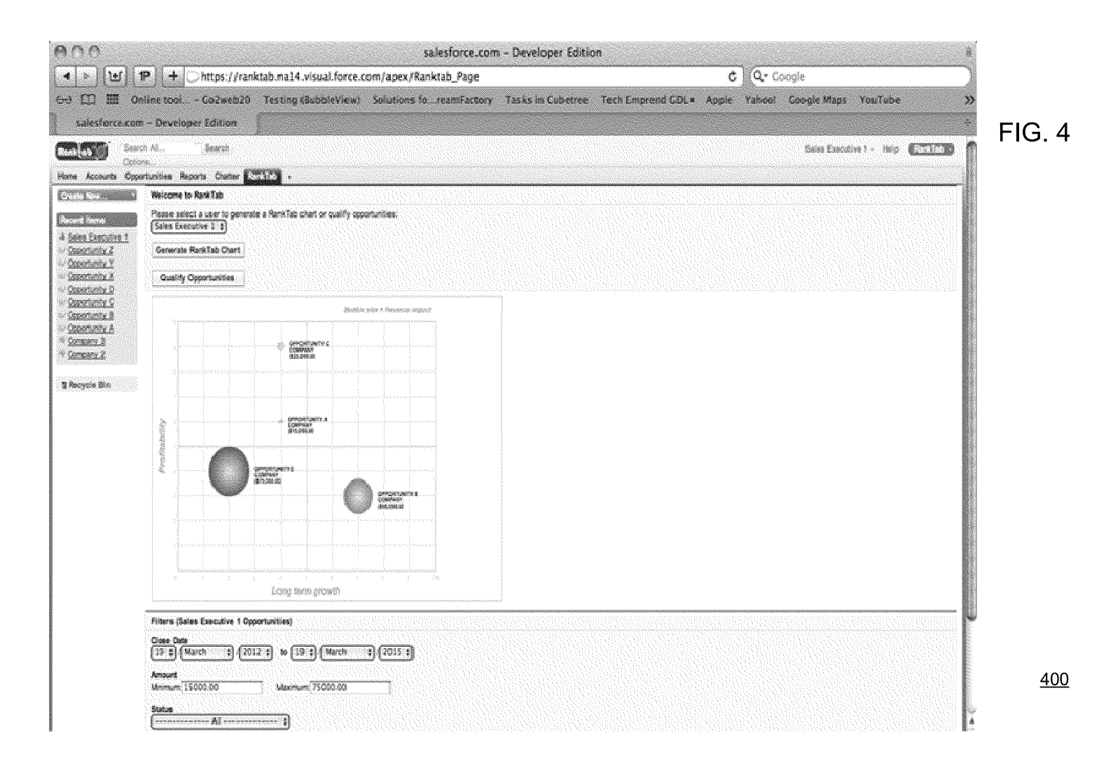

The main function of the application is to graph opportunities; to do so, a Flash file is used as Static Resource to receive all the parameters and graph them according to the given rates. These Parameters are sent through the “flashvars” command so that Flash can interpret these attributes and create the opportunities (FIG. 4).

Pages Visualforce 10—are environment user's interface derivatives based on components for the platform Force.com; the environment includes language based on tags, similar to HTML. A developer creates the page Visualforce by building components, HTML and optional styles on the platform Force.com. Each page is then accessible to a unique URL; when someone accesses to the page, the server processes the page.

Classes Apex 12—The code Apex of Force.com is a solid programming language that is executed on the platform Force.com. Apex is used to add logic to applications; to write database triggers and to programming controllers on the user's interface layer. It has a strong integration with the database and query language, good web service support, and it includes traits such as futures and alignments for its execution on a multi-tenant environment.

Opportunity 14 personalized fields—In Salesforce CRM, “fields” are used to track specific information. For example, for each contact on Salesforce CRM, there are different fields for the information related to them. In this way the contact name would be a field; the title would be another field, and so on. A personalized field is created specifically for the Salesforce CRM of a company.

Flash Static Resources file 16—Visualforce is an environment based on components for user's interface, typically used to display dynamic content. However, not all application files and actives are required to be dynamic. Some of them do not change which are also known as static resources. Such static resources include images, JavaScript files, Flash (SWF) files and cascading style sheet files (CSS).

Even though the invention has been described with reference to individual incorporations on the SalesForce.com application developed for this purpose and named RankTab™, the description is just an example of the invention's application and should not be interpreted as a limitation. For example, the classification or ranking methods (ranking) described above are not required to be limited to business, but also can be used to classify or order (rank) the tacit knowledge of decisions in other entities, such as nonprofit organizations, universities, individuals and service providers. There is also a wide number of variations and adaptations of how the end user can access and use a database that provides the classifications or ranks (rankings). For example, the end user can use other CRMs based on the cloud, such as Oracle OnDemand, Microsoft Dyanmics, Zoho, SugarCRM and others. This and other adaptations and combinations of characteristics and incorporations are revealed in the context of the defined invention for the following claims.

### Quoted References:

1. Customer Profitability Measurement and Management. Robert S. Kaplan and V. G. Narayanan. Harvard Business School, 2001
2. The New Science of Sales ForceProductivity. DianneLedingham, Mark Kovac, and Heidi Locke Simon. Harvard Business Review, 2006
3. Increasing Sales ProductivitybyGettingSalespeopletoWorkSmarter. HarishSujan, Barton A. Weitz, and Mita Sujan. Journal of Personal Selling and Sales Management, 1998.

1. A process of information classification implemented in computer comprising of:
Obtaining real time data that represent the tacit knowledge of people or subjective evaluations which are not contained in the historic files;
processing data obtained to determine a quantitative value of each data obtained;
calculating and determining the status of the respective ratings for each data obtained;
grouping the corresponding data with similar ratings of corresponding data, ordering (rating) each of the ratings criteria of the entry; and
graphing the values obtained in the corresponding order as an indicator of the collective opinion.

2. The process of claim 1, wherein identifying entries that correspond to businesses strategies for each entry, comparing collective tacit information from the entry to corresponding values in a listing of strategic criteria.

3. The process of claim 2, wherein the information from the entry comprises a business opportunity's profitability.

4. The process of claim 2, wherein the information from the entry comprises a business opportunity's long-term growth potential

5. The process of claim 2, wherein the information from the entry comprises a business opportunity's revenue size.

6. The process of claim 1, wherein the scores are the same for all of the entries corresponding to the businesses strategies, and the ratings are determined from a weighted average of the value determined by the users on each criteria.

7. The process of claim 1, wherein for each of the entries corresponding to businesses' strategies, the score depends on a set of factors selected from a group consisting of completeness of the entry, accuracy of the entry, characteristics of the tacit knowledge of the strategy associated with the entry, and payoff from the business opportunity.

8. The process of claim 1, wherein the data includes a plurality of sales and business executives and decision makers that comprises at least one of: business leads, sales opportunities, strategies and decisions; a sales and business opportunities list maintained by a Customer Relationship Manager software and a remote connection enabled through Internet or other telecommunications mediums.

9. The process of claim 8, further comprising a company providing at least one of the customers and strategic projects and priorities management database.

10. The process of claim 1, wherein each of the entries corresponds to an empirical payoff evaluation from one decision maker upon moving forward on a decision or strategy.

11. The process of claim 1, wherein the criteria data comprises tacit knowledge of the upsell potential of a business strategy.

12. The process of claim 1, wherein the criteria data comprises tacit knowledge of the cross-selling potential of a business strategy.

13. The process of claim 1, wherein the criteria data comprises tacit knowledge of the core capabilities alignment of a business strategy.

14. The process of claim 1, wherein the criteria data comprises tacit knowledge of the gross margin of a business strategy.

15. The process of claim 1, wherein the criteria data comprises tacit knowledge of the standardization of the solution offered in relation to the business strategy.

16. The process of dam 1, wherein the criteria data comprises tacit knowledge of the low discounting offered to customers as a business strategy.

17. The process of dam 1, wherein the using the ratings comprises a business intelligence application using the ratings with a ranking algorithm to rank a list of new business opportunities and strategies provided graphically in response to a user query.

18. A computer readable media containing instructions that when executed on a computer performs the process of claim 1.

19. The process of the claim 1 executed on a computing system, comprising: operating a computer system to process a plurality of business strategies, opportunities and decisions; and for each of the entries corresponding to businesses' strategies, wherein the ratings are used to indicate a collective assessment of the opportunities' strategic value for the enterprise.

20. The process of claim 19, further comprising: a user providing tacit knowledge value parameters to a site on the Internet; and the site identifying strategic criteria according to the ratings, and presenting to the user a graphic bubble chart of strategies, business opportunities, projects or decisions in an order that factors in the rakings provided by the user and peers.

21. A process comprising: the process of claim 1, a computer system scanning data containing entries that are unrelated to the transactional historical data from customers and new business opportunities; the computer system identifying in the data entries that corresponds to tacit and empirical knowledge of the business strategy; and in response to each of the entries identified; determining a score for the entry; and using the score to produce a graphical bubble chart representation, wherein the bubbles are used to indicate a community's opinion of the of the tacit strategic value of the business strategy, decision or opportunity.

22. The process of claim 21, wherein the data corresponds to sales opportunities of sales agents, and each of the entries corresponds to a prospect n a corresponding contact in a web-based Customer Relationship Management system.
